(19) United States
(12) Patent Application Publication
(10) Pub. No.: US 2022/0414024 A1
(43) Pub. Date: Dec. 29, 2022

(54) COMMUNICATION METHOD AND RELATED COMMUNICATION APPARATUS AND STORAGE MEDIUM

(71) Applicant: Beijing Tusen Zhitu Technology Co., Ltd., Beijing (CN)

(72) Inventors: Yifan GONG, Beijing (CN); Jiangming JIN, Beijing (CN)

(21) Appl. No.: 17/808,830

(22) Filed: Jun. 24, 2022

(30) Foreign Application Priority Data
Jun. 24, 2021 (CN) 202110703273.2

(51) Int. Cl. G06F 12/14; H04L 9/08; H04L 9/14

(52) U.S. Cl. CPC G06F 12/1408; H04L 9/0869; H04L 9/14

(57) ABSTRACT

The present disclosure provides a communication method, a related communication apparatus, and a storage medium. The communication method includes: generating a first key by using a random sequence; encrypting data by using the first key to generate encrypted data; writing the encrypted data into a memory; encrypting the random sequence and a storage address of the encrypted data in the memory by using a public key; and sending the encrypted storage address and the encrypted random sequence to a second node from a first node.

### CROSS-REFERENCE TO RELATED APPLICATION(S)

The present disclosure claims priority to Chinese Patent Application No. 202110703273.2, titled “COMMUNICATION METHOD AND RELATED COMMUNICATION APPARATUS AND STORAGE MEDIUM”, filed on Jun. 24, 2021, the content of which is incorporated herein by reference in its entirety.

### TECHNICAL FIELD

The present disclosure relates to a communication method, and more particularly, to a communication method for autonomous driving.

### BACKGROUND

With the development of autonomous driving technologies, autonomous vehicles have been applied in the fields of logistics, freight and passenger transportation. When an autonomous vehicle is driving, it generally perceives external road information through its own sensors, such as a radar and a camera. Then, an autonomous driving server, etc., are used to perform operations to complete the decision and planning of the driving of the autonomous vehicle, and finally, control the autonomous vehicle to drive according to the corresponding decision and planning.

In an autonomous driving system, during a single machine communication in multiple processes, a shared memory is generally used for communication in the pursuit of communication efficiency. The multi-process communication based on the shared memory can greatly reduce the copying of data in the memory, thereby greatly reducing the overall data transmission delay.

Since autonomous driving is of an application scenario with very strict safety requirements, the multi-process communication based on the shared memory needs to be guaranteed in terms of functional safety.

### SUMMARY

The present disclosure provides a communication method, a related communication apparatus and a storage medium, which can solve the problem of data security in a shared memory and ensure the security of data in the shared memory.

According to an aspect of the present disclosure, a communication method is provided. The communication method includes:

generating a first key by using a random sequence;

encrypting data by using the first key to generate encrypted data;

writing the encrypted data to a memory;

encrypting the random sequence and a storage address of the encrypted data in the memory by using a public key; and

sending the encrypted storage address and the encrypted random sequence to a second node from a first node.

According to another aspect of the present disclosure, a communication method is provided. The communication method includes:

receiving, by the second node, an encrypted storage address and an encrypted random sequence from the first node, wherein the encrypted storage address and the encrypted random sequence are encrypted by using the public key;

decrypting, by the second node, the encrypted storage address and the encrypted random sequence by using a private key corresponding to the public key;

reading, by the second node, encrypted data from a memory according to the decrypted storage address, wherein the encrypted data is encrypted by using the first key;

generating, by the second node, a second key by using the decrypted random sequence; and

decrypting, by the second node, the encrypted data by using the second key.

According to another aspect of the present disclosure, a communication apparatus is provided. The communication apparatus includes:

a processor; and

a memory storing program instructions, which when being executed by the processor, causing the apparatus to perform the method according to any embodiment of the present application.

According to another aspect of the present disclosure, a computer-readable storage medium is provided. The computer-readable storage medium stores a program therein, wherein the program includes instructions, which when being performed by one or more processors of a computing apparatus, causing the computing apparatus to perform the method according to any embodiment of the present application.

According to the method or apparatus for communication between nodes of the present application, the key is generated by using the random sequence, the data is encrypted by using the key, and the random sequence and the storage address of the encrypted data are then encrypted by using the public key and sent to the second node from the first node. The encryption scheme of the present application integrates a variety of encryption algorithms, solves the problem of data security in the shared memory and ensures the security of the shared memory data, and can prevent the problem of data leakage caused by a malicious process to read data in the shared memory.

### BRIEF DESCRIPTION OF THE DRAWINGS

The accompanying drawings illustrate the embodiments by way of example and constitute a part of the specification, and together with the literal description of the specification, serve to explain exemplary implementations of the embodiments. Apparently, the accompanying drawings in the following description show merely some embodiments of the present invention, and a person of ordinary skill in the art may still derive other drawings from these accompanying drawings without creative efforts. Throughout the drawings, the same reference numbers refer to similar but not necessarily identical elements.

FIG. 1 is a structural diagram of a computing device according to an exemplary embodiment of the present application;

FIG. 2 is a timing diagram of establishing a link between nodes according to an exemplary embodiment of the present application;

FIG. 3 is a flowchart of a process for communication between nodes according to an exemplary embodiment of the present application;

FIG. 4 is a flowchart of a process for communication between nodes according to another exemplary embodiment of the present application;

FIG. 5 is a flowchart of a process for communication between nodes according to yet another exemplary embodiment of the present application;

FIG. 6 is a flowchart of a process for communication between nodes according to still another exemplary embodiment of the present application;

FIG. 7 is a structural diagram of a shared memory space according to an exemplary embodiment of the present application; and

FIG. 8 is a schematic diagram of a data structure for inter-node transmission according to an exemplary embodiment of the present application.

### DETAILED DESCRIPTION

To make the principles, technical solutions and advantages of the present invention clearer, the present invention will be described in detail below in conjunction with the accompanying drawings. Of course, the described embodiments are merely some embodiments, rather than all embodiments, of the present invention. Based on the embodiments of the present invention, all other embodiments derived by a person of ordinary skill in the art without creative efforts shall fall within the protection scope of the present invention.

In the present disclosure, the term “plurality” refers to two or more, unless specifically defined otherwise. In the present disclosure, the term “and/or” describes the association of contextual objects, covering any and all possible combinations of the listed objects. The character “I” generally indicates an “or” relationship between the contextual objects.

In the present disclosure, unless otherwise specified, the terms “first”, “second” and the like are used to distinguish similar objects, and are not intended to limit their positional, chronological, or importance relationships. It should be understood that terms used in this way may be interchanged where appropriate so that the embodiments of the present invention described herein can be implemented in a sequence other than those illustrated or described herein.

Furthermore, the terms “including” and “having” and any variants thereof are intended to cover non-exclusive inclusions. For example, a process, method, system, product, or device that includes a series of steps or units is not necessarily limited to those steps or units that are clearly listed, but may include other steps or units that are not clearly listed or are inherent to such processes, methods, products, or devices.

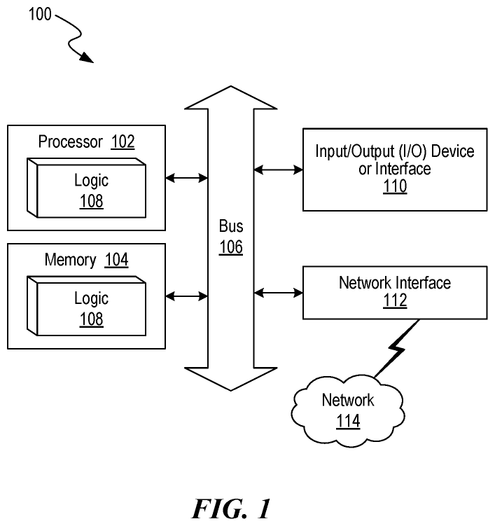

FIG. 1 shows a schematic diagram of a computing device 100 in which the various techniques disclosed herein may be implemented. A set of instructions within the computing device when executed and/or a processing logic when activated may cause the computing device to perform any one or more of the methods described and/or claimed herein. The computer device 100 may operate as a stand-alone device, or may be connected (e.g., networked) to other devices. In a networked deployment, the computing device 100 may operate as a server or client device in a server-client network environment, or as a peer device in a peer-to-peer (or distributed) network environment. The computing device 100 may be a personal computer (PC), a laptop computer, a tablet computing system, a personal digital assistant (PDA), a cellular phone, a smart phone, a network router, a switch or bridge or any device capable of executing a set of instructions (successively or otherwise) that specifies actions to be taken by that computing device or initiating a processing logic. Further, although only a single computing device 100 is illustrated, the term “computing device” may also be understood to include any collection of computing devices that execute, individually or in combination, a set (or sets of instructions) of instructions to perform any one or more of the methods described and/or claimed herein.

The computing device 100 may include a processor 102 (e.g., a system-on-chip (SoC), a general-purpose processing core, a graphic core, and optional other processing logic) and a memory 104 (also known as an internal storage here) that may communicate with each other via a bus 106 or other data transfer system. The computing device 100 may also include various input/output (I/O) devices and/or interfaces 110, such as a touch screen display, an audio jack and a voice interface, and an optional network interface 112. In an exemplary embodiment, the network interface 112 may include one or more radio transceivers configured to be used together with any one or more standard wireless and/or cellular protocols or access technologies (e.g., second generation (2G), 2.5 generation, third generation (3G), fourth generation (4G) and next generation radio access, global system for mobile communications (GSM), general packet radio service (GPRS), enhanced data GSM environment (EDGE), wideband code division multiple access (WCDMA), LTE, CDMA2000, WLAN, and wireless router (WR) mesh). The network interface 112 may also be configured to be used together with various other wired and/or wireless communication protocols (including TCP/IP, UDP, SIP, SMS, RTP, WAP, CDMA, TDMA, UMTS, UWB, WiFi, WiMax, Bluetooth©, IEEE802.11x, etc.). Essentially, the network interface 112 may include or support any wired and/or wireless communication and data processing mechanism through which information/data may be propagated between the computing device 100 and another computing or communication system via a network 114.

The memory 104 may represent a machine-readable medium (or computer-readable storage medium) on which one or more sets of instructions, software, firmware or other processing logics (e.g., logic 108) that implement any one or more of the methods or functions described and/or claimed herein are stored. The logic 108, or a portion thereof, may also reside entirely or at least partially within the processor 102 during the execution by the computing device 100. In this way, the memory 104 and the processor 102 may also constitute a machine-readable medium (or a computer-readable storage medium). The logic 108, or a portion thereof, may also be configured as a processing logic or logic, at least a portion of which is partially implemented in hardware. The logic 108, or a portion thereof, may also be transmitted or received over the network 114 via the network interface 112. Although the machine-readable medium (or computer-readable storage medium) of an exemplary embodiment may be a single medium, the term “machine-readable medium” (or computer-readable storage medium) should be understood to include a single non-transitory medium or multiple non-transitory mediums (such as a centralized or distributed database and/or associated caching and computing systems) that store one or more sets of instructions. The term “machine-readable medium” (or computer-readable storage medium) may also be understood to include any non-transitory medium that is capable of storing, encoding, or carrying a set of instructions for execution by a machine (e.g., a computer) and causing the machine (e.g., a computer) to perform any one or more of the methods in various embodiments, or is capable of storing, encoding, or carrying data structures that are utilized by or associated with such a set of instructions. The term “machine-readable medium” (or computer-readable storage medium) may thus be understood to include, but not be limited to, a solid-state memory, an optical medium, and a magnetic medium.

When the computing device 100 performs multi-process communication (especially when the computing device 100 is applied in an autonomous driving system and performs multi-process communication), a shared memory is generally used for communication in the pursuit of communication efficiency. The multi-process communication based on the shared memory can greatly reduce the copying of data in the memory, thereby greatly reducing the overall data transmission delay. This feature is very important in the application scenario of autonomous driving, which is very sensitive to delay.

The inventors of the present application have noticed that the technical solution based on the shared memory will face many problems and challenges in terms of functional safety. For example, the shared memory itself is public, and it is necessary to prevent unrelated processes from maliciously stealing data. If this problem has not been solved yet in the technical solution based on the shared memory, it will affect the safety of an autonomous driving system, which is unfavorable for the application scenario of autonomous driving with very strict safety requirements.

In order to solve the above problem, an embodiment of the present application provides an inter-node communication method (or an inter-node data transmission method). The method includes: generating a first key by using a random sequence; encrypting data by using the first key to generate encrypted data; writing the encrypted data into a memory; encrypting a storage address of the encrypted data in the memory and the random sequence by using a public key; and sending the encrypted storage address and the encrypted random sequence to a second node from a first node. An example of the node is a process.

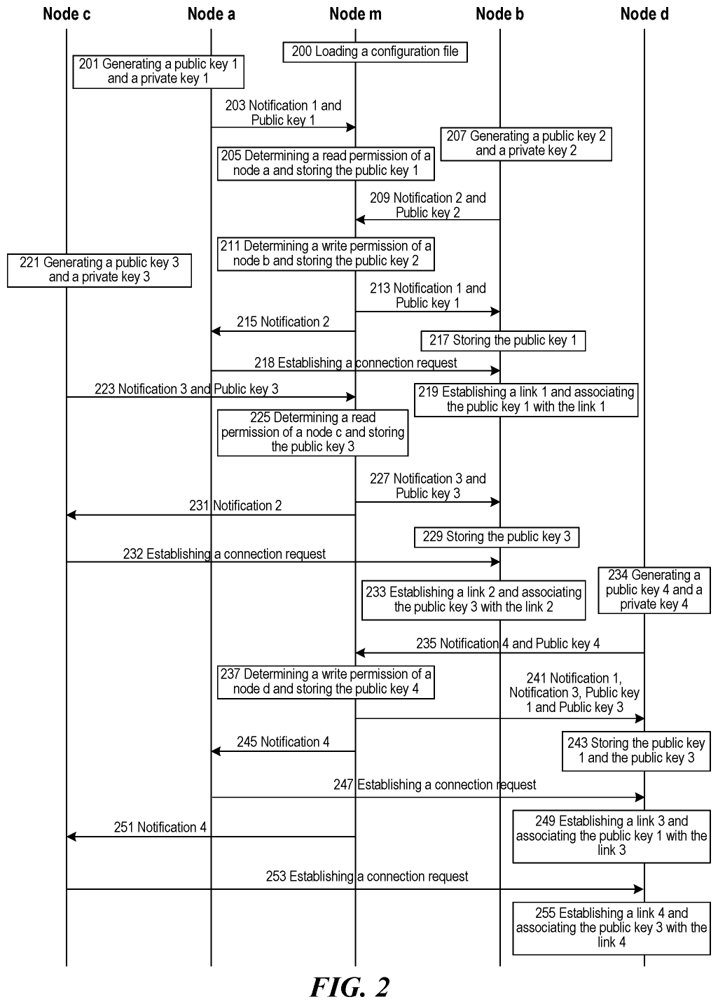

According to this embodiment of the present application, in order to communicate between nodes, a link is first established between the nodes. FIG. 2 is a timing diagram of establishing a link between nodes according to an exemplary embodiment of the present application. A central node (e.g., a node m) and a plurality of other nodes (i.e., non-central nodes), such as a node a, a node b, a node c, and a node d, are shown in FIG. 2.

In this application, the central node is also referred to as a management node or a service discovery node or a master node, and is responsible for managing the startup or exit of other nodes (i.e., non-central nodes).

Those skilled in the art may understand that there may be more or less non-central nodes although four non-central nodes are shown in FIG. 2. Those skilled in the art may also understand that part or all of the functions of the central node (e.g., node m) may be undertaken by one or more other nodes (e.g., node a, node b, node c, or node d), and there may be no central node at this time.

When the central node is started, a configuration file will be loaded. The configuration file has user-defined permission (such as read and write permissions) information for respective nodes (non-central nodes) to a predetermined space (e.g., a shared memory space) in a memory. The central node configures the permissions of the nodes according to the permission information of the nodes in the configuration file, for example, determines which node or nodes have a read permission to the shared memory space, and which node or nodes have a write permission to the shared memory space. FIG. 7 is a structural diagram of the shared memory space according to an exemplary embodiment of the present application. As shown in FIG. 7, an exemplary shared memory space includes at least one shared memory region 710. The shared memory region 710 may include a permission management segment 711 and a data segment 712. The configuration file loaded by the central node may be stored in the permission management segment 711. Data may be stored in the data segment 712. According to this embodiment of the present application, the central node has read and write permissions to the permission management segment of the shared memory region, and all other nodes (i.e., non-central nodes) only have a read permission, but no write permission, to the permission management segment. When a non-central node has a write permission to the shared memory space, this node may write data or other contents into, for example, a data segment (e.g., the data segment 712 in FIG. 7) of the shared memory space.

A functional safety module is loaded when the node is started. The functional safety module may include a plurality of modules or algorithms. The functional safety module may include, for example, a symmetric key encryption algorithm, a public key encryption and private key decryption algorithm, and/or a check algorithm. The check algorithm may be, for example, various hash algorithms, such as a MD5 check algorithm.

The symmetric key encryption algorithm may include a random sequence generation algorithm (e.g., a random binary code generation algorithm), a key generation algorithm, and an encryption and decryption algorithm. The random sequence generation algorithm is used to randomly generate a random sequence. An example of the random sequence is a random binary code (such as a random string). The key generation algorithm is used to generate a key from the random sequence by using, e.g., a hash method. The encryption and decryption algorithm is used to encrypt or decrypt data that needs to be encrypted or decrypted by using the key.

The public key encryption and private key decryption algorithm may include a public key and private key generation algorithm, a public key encryption algorithm, and a private key decryption algorithm. The public key and private key generation algorithm randomly generates a pair of matching public and private keys.

When a node (non-central node) is started or exits, this node may exchange data with the central node (for example, this node may send a public key and/or notification to the central node upon the startup of this node), and the central node may notify other active nodes (i.e., other non-central nodes that have been started but not exited) of the start or exit event of this node.

Specifically, after the node loads the functional safety module, it will call the public key and private key generation algorithm in the functional safety module to generate a pair of matching public and private keys. The node may save the private key. As the basis for decryption, the node may send the public key to the central node, and the central node may save the received public key and send the received public key to other nodes. The central node may, for example, store the received public key in the permission management segment in association with the node that sends (or generates) the public key.

In some embodiments, in addition to sending the public key to the central node, the node may also send a notification (i.e., a node start event notification) to the central node, and notifies the central node that it has been started. In some embodiments, the node may make an appointment that the central node receiving the public key means the node that sends the public key by default has been started, without additionally sending another notification to the central node.

In some embodiments, the central node and the non-central nodes mentioned herein are nodes under the same topic.

As shown in FIG. 2, at 200, a central node, i.e., the node m, is started, and the node m loads a configuration file in the starting process. For example, the node m may write the configuration file into the permission management segment 711 shown in FIG. 7.

At 201, the node a is started. The node a may load the functional safety module in the starting process, and generate a pair of matching public and private keys through the public key and private key generation algorithm in the functional safety module (in order to distinguish them from other public and private keys, the public and private keys generated by the node a are also referred to as a public key 1 and a private key 1).

At 203, the node a sends the public key 1 to the node m, and meanwhile, the node a may send a notification 1 to the node m to notify the node m of the event that the node a has been started (in order to distinguish it from other notifications, the notification sent by the node a is referred to as the notification 1). At the same time, the node a may save the private key 1. The node a, for example, save the private key 1 in a database managed by the node a.

At 205, the node m may use the configuration file to determine a permission of the node a (i.e., read and write permissions to the shared memory space), and store the public key 1.

Specifically, the node m may access a configuration file in which permission messages of a plurality of nodes including the node a, as well as the node b, the node c and the node d to be described below, that are pre-specified by a user, are stored. The node m determines the permission of the node a according to the configuration file.

For the purpose of explanation here, it is assumed that the permission of the node a is specified in the configuration file as a read permission (that is, the node a may read data or other content in the shared memory space but cannot write data or other content into the shared memory space). After determining that the node a has a read permission, the node m may determine whether there is an active node having a write permission (that is, a node having a write permission to the shared memory space that has been started but not exited).

If there is an active node having a write permission, the node m may send the notification 1 and the public key 1 to the active node having the write permission. In an example of FIG. 2, since there is no active node having a write permission at this time, the node m determines that it is not necessary to send the notification 1 and the public key 1 for the time being. The node m may wait for a node having a write permission to start, and then send the notification 1 and the public key 1 to this node having the write permission.

It should be noted that, instead of sending the notification 1 to the node having the write permission, the node m may generate a new notification 1′ and send it to the node having the write permission to notify an event that the node a has been started.

At 207, the node b is started. The node b may load the functional safety module in the starting process, and generate a pair of matching public key 2 and private key 2 through the public key and private key generation algorithm in the functional safety module. The functional safety module loaded by the node b may be the same as the functional safety module loaded by the node a.

At 209, the node b sends the public key 2 to the node m, and meanwhile, the node b may send a notification 2 to the node m to notify the node m of an event that the node b has been started. At the same time, the node b may save the private key 2. The node b, for example, save the private key 2 in a database managed by the node b.

At 211, the node m may use the configuration file to determine a permission of the node b (i.e., read and write permissions to the shared memory space), and store the public key 2.

For the purpose of explanation here, it is assumed that the permission of the node b is specified in the configuration file as a write permission (that is, the node b may read data or other content in the shared memory space or write data or other content into the shared memory space). After determining that the node b has the write permission, the node m may determine whether there is an active node having a read permission (that is, a node having a read permission to the shared memory space that has been started but not exited).

If there is an active node having a read permission, the node m may send the notification 2 to the active node having the read permission. In the example of FIG. 2, the node m determines that the node a is an active node having a read permission at this time.

In this embodiment of the present application, when the node having the read permission is started subsequently, the node m may also send the notification 2 to this node having the read permission.

At 213, since the node m has received the notification 2 and knows that the node b has been started, the node m may send the public key 1 to the node b having the write permission, and meanwhile may send the notification 1 (or notification 1′) to the node b having the write permission to notify the node b of the event that the node a has been started.

At 215, since the node m has received the notification 1 and knows that the node a has been started, the node m may send the notification 2 to the node a to notify the node a of an event that the node b has been started. It should be noted that, instead of sending the notification 2 to the node a, the node m may generate a new notification 2′ and send it to the node a to notify the event that the node b has been started.

At 217, the node b receives the public key 1 from the node m, and then store the public key 1, for example, store the public key 1 in the database managed by the node b.

At 218, when the node a having the read permission receives the notification 2 (or notification 2′) from the node m, since the node a knows that the node b having the write permission has been started, the node a may send a link establishment request to the node b to attempt to establish a link with the node b.

At 219, after receiving the link establishment request from the node a, the node b having the write permission may establish the link 1 in response to the request (to distinguish it from other links, here the link between the node a and the node b is referred to as the link 1), find the public key 1 of the node a, and associate the public key 1 with the link 1. In this way, when the node b transmits information to the node a through the link 1, the information may be encrypted by using the public key 1 associated with the link 1, such that the node a decrypts this information by using the corresponding private key 1.

At 221, the node c is started. The node c may load the functional safety module in the starting process, and generate a pair of matching public key 3 and private key 3 through the public key and private key generation algorithm in the functional safety module.

At 223, the node c sends the public key 3 to the node m, and meanwhile, the node c may send a notification 3 to the node m to notify the node m of an event that the node c has been started. At the same time, the node c may save the private key 3. The node c, for example, save the private key 3 in a database managed by the node c.

At 225, the node m may use the configuration file to determine a permission of the node c (i.e., read and write permissions to the shared memory space), and store the public key 3.

Specifically, the node m may access the configuration file, and determine the permission of the node c according to the configuration file.

For the purpose of explanation here, it is assumed that the permission of the node c is specified in the configuration file as a read permission (that is, the node c may read data or other content in the shared memory space but cannot write data or other content into the shared memory space). After determining that the node c has the read permission, the node m may determine whether there is an active node having a write permission (that is, a node having a write permission to the shared memory space that has been started but not exited).

If there is an active node having a write permission, the node m may send the notification 3 and the public key 3 to the active node having the write permission. In the example of FIG. 2, the node b is an active node having a write permission at this time.

According to this embodiment of the present application, when a node having a write permission is started subsequently, the node m may also send the notification 3 and the public key 3 to this node having the write permission.

At 227, since the node m has received the notification 2 and knows that the node b has been started, the node m may send the public key 3 to the node b having the write permission, and meanwhile may send the notification 3 to the node b having the write permission to notify the node b of the event that the node c has been started. It should be noted that, instead of sending the notification 3 to the node b, the node m may generate a new notification 3′ and send it to the node b to notify an event that the node c has been started.

At 229, the node b receives the public key 3 from the node m, and then store the public key 3. The node b, for example, store the public key 3 in the database managed by the node b.

At 231, since the node m has received the notification 3 and knows that the node c has been started, the node m may send the notification 2 (or notification 2′) to the node c to notify the node c of the event that the node b has been started.

At 232, after the node c having the read permission receives the notification 2 (or notification 2′) from the node m, since the node c knows that the node b having the write permission has been started, the node c may send a link establishment request to the node b to attempt to establish a link with the node b.

At 233, after receiving the link establishment request from the node c, the node b having the write permission may establish a link 2 in response to the request, find the public key 3 of the node c, and associate the public key 3 with the link 2. In this way, when the node b transmits information to the node c through the link 2, the information may be encrypted by using the public key 3 associated with the link 2, such that the node c decrypts this information by using the corresponding private key 3.

At 234, the node d is started. The node d may load the functional safety module in the starting process, and generate a pair of matching public key 4 and private key 4 through the public key and private key generation algorithm in the functional safety module. The functional safety module loaded by the node d may be the same as the functional safety modules loaded by the node a, the node b and the node c.

At 235, the node d sends the public key 4 to the node m, and meanwhile, the node d may send a notification 4 to the node m to notify the node m of an event that the node d has been started. At the same time, the node d may save the private key 4. The node d, for example, save the private key 4 in a database managed by the node d.

At 237, the node m may use the configuration file to determine a permission of the node d (i.e., read and write permissions to the shared memory space), and store the public key 4.

For the purpose of explanation here, it is assumed that the permission of the node d is specified in the configuration file as a write permission (that is, the node d may read data or other content in the shared memory space or write data or other content into the shared memory space). After determining that the node d has the write permission, the node m may determine whether there is an active node having a read permission (that is, a node having a read permission to the shared memory space that has been started but not exited).

If there is an active node having a read permission, the node m may send the notification 4 to the active node having the read permission. In the example of FIG. 2, the node m determines that the node a and the node c are active nodes having a read permission at this time.

In this embodiment of the present application, when a node having a read permission is started subsequently, the node m may also send the notification 4 to this node having the read permission.

At 241, since the node m has received the notification 4 and knows that the node d has been started, the node m may send the public key 1 and the public key 3 to the node d having the write permission, and meanwhile may send the notification 1 (or notification 1′) and the notification 3 (or notification 3′) to the node d having the write permission to notify the node d of the event that the node a and the node c have been started.

At 243, the node d receives the public key 1 and the public key 3 from the node m, and then store the public key 1 and the public key 3. The node d, for example, store the public key 1 and the public key 3 in the database managed by the node d.

At 245, since the node m has received the notification 1 and knows that the node a has been started, the node m may send the notification 4 to the node a to notify the node a of the event that the node d has been started. It should be noted that, instead of sending the notification 4 to the node a, the node m may generate a new notification 4′ and send it to the node a to notify the event that the node d has been started.

At 247, when the node a having the read permission receives the notification 4 (or notification 4′) from the node m, since the node a knows that the node d having the write permission has been started, the node a may send a link establishment request to the node d to attempt to establish a link with the node d.

At 249, after receiving the link establishment request from the node a, the node d having the write permission may establish a link 3 in response to the request, find the public key 1 of the node a, and associate the public key 1 with the link 3. In this way, when the node d transmits information to the node a through the link 3, the information may be encrypted by using the public key 1 associated with the link 3, such that the node a decrypts this information by using the corresponding private key 1.

At 251, since the node m has received the notification 3 and knows that the node c has been started, the node m may send the notification 4 (or notification 4′) to the node c to notify the node c of the event that the node d has been started.

At 253, when the node c having the read permission receives the notification 4 (or notification 4′) from the node m, since the node c knows that the node d having the write permission has been started, the node c may send a link establishment request to the node d to attempt to establish a link with the node d.

At 255, after receiving the link establishment request from the node c, the node d having the write permission may establish a link 4 in response to the request, find the public key 3 of the node c, and associate the public key 3 with the link 4. In this way, when the node d transmits information to the node c through the link 4, the information may be encrypted by using the public key 3 associated with the link 4, such that the node c decrypts this information by using the corresponding private key 3.

It should be noted that although in the above description, the node may send the public key and the notification to the node m after this node is started, those skilled in the art may understand that the node can also send the notification to the node m first after it is started, and then send the public key to the node m when needed, for example, when receiving a request from the node m. Alternatively, some nodes send the public keys and the notifications to the node m after starting, and some nodes only send the notifications to the node m after starting. For example, in the above 209, the node b may only send the notification 2 to the node m, and then send the public key 2 to the node m if required. Similarly, in the above 235, the node d may only send the notification 4 to the node m, and then send the public key 4 to the node m if required.

According to this embodiment of the present application, nodes may be subjected to permission configuration according to permission information of the nodes in the configuration file, which can solve the problem of permission management for a plurality of nodes to access the same shared memory, thereby preventing irrelevant processes from acquiring access permissions to data in the shared memory.

According to this embodiment of the present application, when a node having a read permission knows that a node having a write permission has been started (for example, it is known that a node having a write permission has been started according to a notification of the central node), the node having the read permission sends a link establishment request to the node having the write permission to attempt to establish a link with the node having the write permission. After receiving the link establishment request from the node having the read permission, the node having the write permission may establish a link in response to the request, find a public key corresponding to the node having a read permission, and associate the public key with the link. In this way, when the node having the write permission transmits information to the node having the read permission through the link, the information may be encrypted by using the public key associated with the node having the read permission, such that the node having the read permission decrypts this information by using the corresponding private key. After a link is established between nodes, the communication between the nodes can be performed through the link.

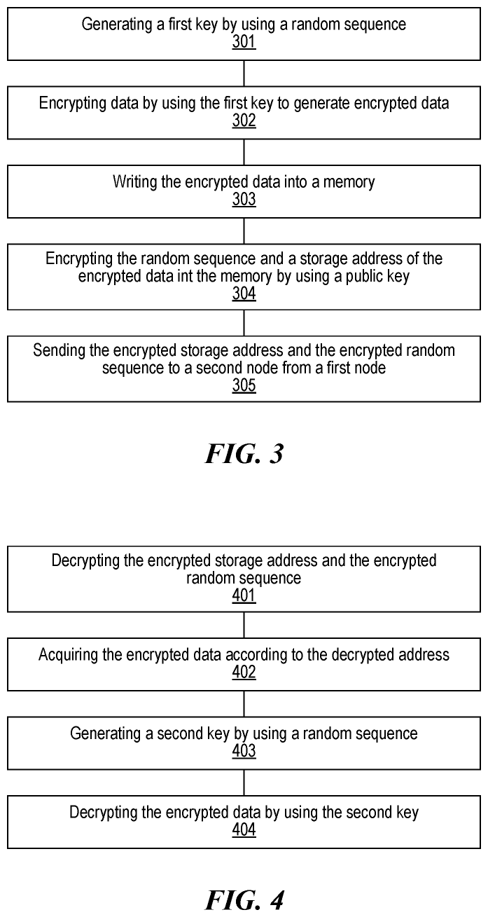

FIG. 3 is a flowchart of a process for communication between nodes after the link is established according to an exemplary embodiment of the present application.

As shown in FIG. 3, at 301, a first node (also referred to as a sender node) generates a first key by using a random sequence (e.g., a random binary code). The first node may be a node having a write permission, such as a node b in FIG. 2. The first node encrypts data to be sent to a second node (also referred to as a receiver node) in order to ensure the security of the data. The second node may be a node having a read permission, such as the node a in FIG. 2.

In the example where the first node is the node b in FIG. 2 and the second node is the node a in FIG. 2, the step 301 in FIG. 3 may be performed after the step 219 in FIG. 2. That is, when the step 301 is executed, the link 1 has been established between the node a and the node b. In the example where the first node is the node d in FIG. 2 and the second node is the node c in FIG. 2, the step 301 in FIG. 3 may be performed after the step 255 in FIG. 2. That is, when the step 301 is executed, the link 4 has been established between the node c and the node d.

Those skilled in the art can understand that the node b and the node d are only examples of the first node, and similarly, the node a and the node c are only examples of the second node, wherein the first node may be any node having a write permission, and the second node may be any node having a read permission. In some embodiments, in the case that inter-node communication is performed, a link has been established between the first node and the second node through a third node (e.g., a central node) according to the method shown in FIG. 2.

As described above, a node (e.g., the first node) may load the functional safety module in the starting process, call a random sequence generation algorithm in the functional safety module to generate a random sequence, and then call a key generation algorithm in the functional safety module to generate a key by using the random sequence. The random sequence may be a random binary code, and an example of the random binary code is a random string.

In step 302, the first node calls an encryption algorithm to encrypt data by using the first key to generate encrypted data. For example, the first node calls the encryption algorithm in the encryption and decryption algorithm of the functional safety module to encrypt data by using the first key to generate encrypted data.

In step 303, the first node writes the encrypted data into a memory.

For example, the first node may write the encrypted data into a predetermined space of the memory (e.g., a shared memory space).

In some embodiments, the first node may apply for a storage space in the shared memory space according to the size of the encrypted data, write the encrypted data into the memory according to the applied storage space, and take an address of the storage space (e.g., a start address of the storage space) as a storage address of the encrypted data in the memory.

For example, as shown in FIG. 7, the shared memory space includes a shared memory region 710. The shared memory region 710 may include a permission management segment 711 and a data segment 712. The shared memory region 710 may also include a data management segment not shown in FIG. 7. The first node may apply for a storage space from the data management segment according to the size of the encrypted data, the data management segment may allocate a storage space 713 for the first node in the data segment 712 according to the application of the first node, and the first node may write the encrypted data into the storage space 713.

In step 304, the first node encrypts the random sequence and the storage address of the encrypted data in the memory by using a public key. The public key is generated by the second node in the starting process and sent to the first node (for example, the second node may send the public key to the first node via a third node, i.e., the central node), and the second node stores a private key corresponding to the public key. The second node may use the private key to decrypt content or information (e.g., the storage addresses and the random sequences) encrypted by using the public key.

In step 305, the encrypted storage address and the encrypted random sequence are sent to the second node from the first node. Since the storage address and the random sequence sent by the first node to the second node are encrypted, the security of these contents or information during transmission can be guaranteed.

FIG. 4 is a flowchart of a process for communication between nodes according to another exemplary embodiment of the present application. The process of FIG. 4 may occur after the process of FIG. 3.

As shown in FIG. 4, in step 401, the second node decrypts the encrypted storage address and the encrypted random sequence.

After the first node sends the encrypted storage address and the encrypted random sequence to the second node (see the step 305 in FIG. 3), the second node decrypts the received encrypted storage address and encrypted random sequence.

As described above, the storage address and the random sequence are encrypted by using the public key. The public key is generated by the second node in the starting process and sent to the first node, and the second node stores a private key corresponding to the public key. The second node may use the private key to decrypt content encrypted by using the public key.

In step 402, the encrypted data is acquired by the second node according to the decrypted storage address.

The second node reads the encrypted data from the memory according to the decrypted storage address.

In step 403, the second node generates a second key by using the decrypted random sequence.

The second node has loaded a functional safety module in the starting process, wherein the functional safety module is the same as the functional safety module loaded by the first node in the starting process. That is, the first node and the second node may call the same key generation algorithm. In this way, the second key generated by the second node by using the random sequence may be the same as the first key generated by the first node by using the random sequence.

In step 404, the second node decrypts the encrypted data by using the second key.

According to this embodiment of the present application, when a node wants to exit when the communication is completed, it can send a notification to the central node; and the central node may send a corresponding notification to another node that forms a link with this node in order to disconnect this link. For example, if the node a wants to exit when the node a and the node b complete communication through the link 1, the node a may send a notification to the node m to notify the node m of an exit event of the node a, and the node m may then notify the node b of the exit event of the node a; and the node b may disconnect the link 1 at this time. Similarly, if the node b wants to exit when the node a and the node b complete communication through the link 1, the node b may send a notification to the node m to notify the node m of an exit event of the node b, and meanwhile the node b may disconnect the link 1; and the node m may then notify the node b of an exit event of the node a.

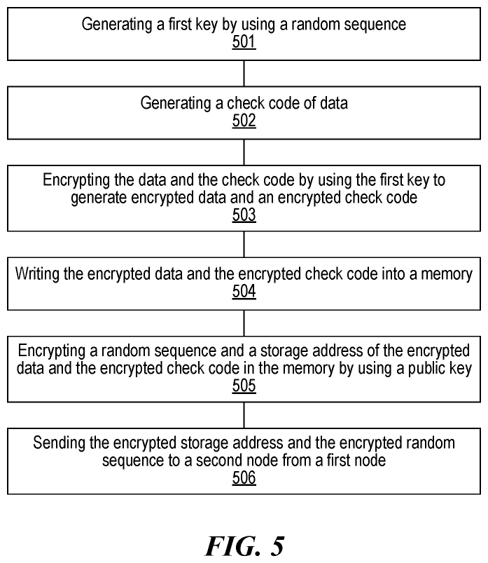

FIG. 5 is a flowchart of a process for communication between nodes according to another exemplary embodiment of the present application. The communication process in the embodiment in FIG. 5 is basically the same as that in FIG. 3, except that the first node in FIG. 5 also generates a check code of data and sends the encrypted check code to the first node. The same parts of the embodiment in FIG. 5 and the embodiment in FIG. 3 are not be described in detail below, but the differences therebetween are emphatically described.

As shown in FIG. 5, at 501, a first node (also referred to as a sender node) generates a first key by using a random sequence (e.g., a random binary code). The first node may, for example, be a node b in FIG. 2. The first node encrypts data to be sent to a second node (also referred to as a receiver node) in order to ensure the security of the data. The second node may, for example, be a node a in FIG. 2. As shown in FIG. 2, the link 1 has been established between the node a and the node b.

The first node that has loaded the functional safety module in the starting process may call a random sequence generation algorithm in the functional safety module to generate a random sequence, and then call a key generation algorithm in the functional safety module to generate a key by using the random sequence. The random sequence may be a random binary code, and an example of the random binary code is a random string.

In step 502, the first node calls a check algorithm to generate a check code of data. The check algorithm may be, for example, various hash algorithms, such as a MD5 check algorithm. The generated check code may be, for example, an MD5 value of the data.

In step 503, the first node calls an encryption algorithm to encrypt the data and the check code by using the first key to generate encrypted data and an encrypted check code. For example, the first node calls the encryption algorithm in the functional safety module to encrypt the data and the check code by using the first key to generate the encrypted data and the encrypted check code.

In step 504, the first node writes the encrypted data and the encrypted check code into the memory.

In some embodiments, the first node may apply for a storage space in the shared memory space according to the size of the encrypted data and the size of the encrypted check code, write the encrypted data and the encrypted check code into the memory according to the applied storage space, and take an address of the storage space as a storage address of the encrypted data and the encrypted check code in the memory.

For example, the first node may apply for a storage space from the data management segment in the shared memory region according to the size of the encrypted data and the size of the encrypted check code, the data management segment may allocate a storage space for the first node in the data segment of the shared memory region according to the application of the first node, and the first node may write the encrypted data into the storage space.

In step 505, the first node encrypts the random sequence and the storage address of the encrypted data and the encrypted check code in the memory by using a public key. The public key is generated by the second node in the starting process and sent to the first node, and the second node stores a private key corresponding to the public key. The second node may use the private key to decrypt the content encrypted by using the public key.

In step 506, the encrypted storage address and the encrypted random sequence are sent to the second node from the first node. Since the storage address and the random sequence sent to the second node from the first node are encrypted, the security of these contents or information during transmission can be guaranteed.

FIG. 8 shows a data structure 800 sent to the second node from the first node, the data structure 800 including an encrypted storage address 801 and an encrypted random sequence 802.

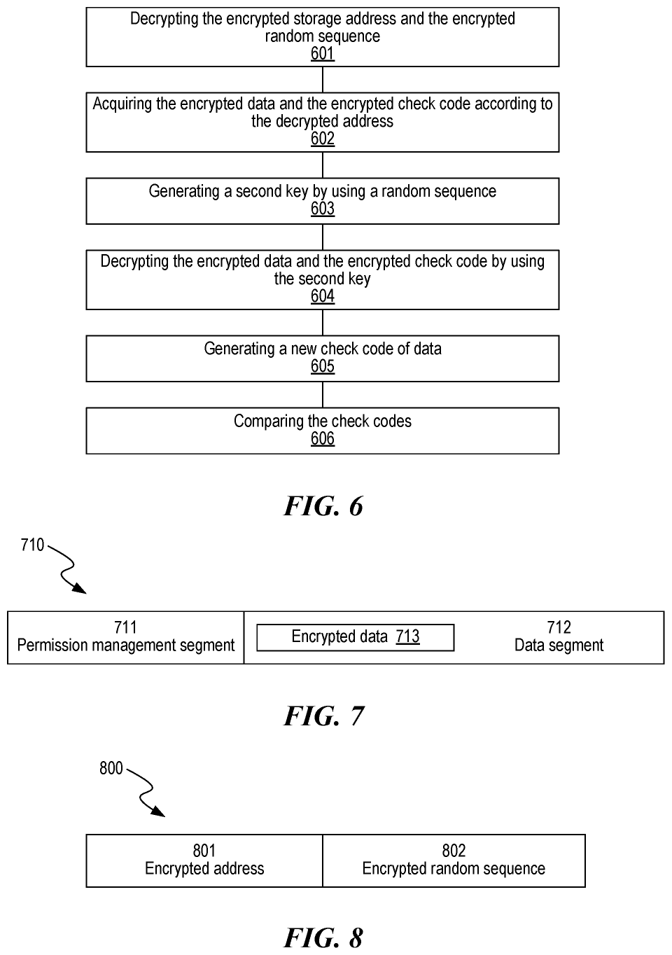

FIG. 6 is a flowchart of a process for communication between nodes according to still another exemplary embodiment of the present application. The process of FIG. 6 may occur after the process of FIG. 5. The communication process in the embodiment of FIG. 6 is basically the same as that of FIG. 4. The same parts of the embodiment in FIG. 6 and the embodiment in FIG. 4 are not be described in detail below, but the differences therebetween are emphatically described.

As shown in FIG. 6, in step 601, the second node decrypts the encrypted storage address and the encrypted random sequence.

After the first node sends the encrypted storage address and the encrypted random sequence to the second node (see the step 506 in FIG. 5), the second node decrypts the received encrypted storage address and encrypted random sequence. The step 601 is similar to the step 401 in the embodiment of FIG. 4.

In step 602, the second node acquires the encrypted data and the encrypted check code according to the decrypted storage address.

In step 603, the second node generates a second key by using the decrypted random sequence. The step 603 is similar to the step 403 in the embodiment of FIG. 4.

The second node has loaded a functional safety module in the starting process, wherein the functional safety module is the same as the functional safety module loaded by the first node in the starting process. That is, the first node and the second node may call the same key generation algorithm; and the second key generated by the second node by using the random sequence may be the same as the first key generated by the first node by using the random sequence.

In step 604, the second node decrypts the encrypted data and the encrypted check code by using the second key.

In step 605, the second node calls a check algorithm to generate a new check code of data. The check algorithm may be, for example, various hash algorithms, such as a MD5 check algorithm. The generated check code may be, for example, an MD5 value of the data.

It should be noted that the check algorithm called by the second node and the check algorithm called by the first node may be the same algorithm.

In step 606, the second node matches the new check code generated in the step 605 with the check code decrypted in the step 604. If the new check code is matched with the decrypted check code, it means that the data decrypted in the step 604 is valid data; and if the new check code is not matched with the decrypted check code, it means that the data decrypted in the step 604 is invalid data, and may be discarded.

According to this embodiment of the present application, by generating the new check code and matching it with the decrypted check code, the problem that the write process writes wrong data into the shared memory and causes the read process to crash can be avoided.

In the embodiments corresponding to FIGS. 3 to 6, the first node may be, for example, the node b in FIG. 2, and the second node may be, for example, the node a in FIG. 2. As shown in FIG. 2, the link 1 is established between the node a and the node b. The first node may also be the node b in FIG. 2, and the second node may be the node c in FIG. 2; and as shown in FIG. 2, the link 2 is established between the node c and the node b. The first node may also be the node d in FIG. 2, and the second node may be, for example, the node a in FIG. 2; and as shown in FIG. 2, the link 3 is established between the node a and the node d. The first node may also be the node d in FIG. 2, and the second node may be, for example, the node c in FIG. 2; and as shown in FIG. 2, the link 4 is established between the node c and the node d.

Some embodiments described herein are described in the general context of methods or processes, which in one embodiment may be implemented by a computer program product in a computer-readable medium, wherein the computer program product may include computer-executable instructions (e.g., program codes), which may be executed, for example, by a computer in a networked environment. The computer readable media may include removable and non-removable storage devices, including, but not limited to, a read only memory (ROM), a random access memory (RAM), a compact disc (CD), a digital versatile disc (DVD), and the like. Therefore, the computer-readable storage medium may be a non-transitory storage medium. Generally, program modules may include routines, programs, object, components, logic, data structures, etc. that perform particular tasks or implement particular abstract data types. The computer or processor-executable instructions, associated data structures, and program modules represent examples of program codes for executing the steps of the methods disclosed herein. The specific sequences of such executable instructions or associated data structures represent examples of corresponding actions for implementing the functions described in the steps or processes.

Some of the disclosed embodiments may be implemented as devices or modules using hardware circuits, software, or a combination thereof. For example, the hardware circuit implementation may include discrete analog and/or digital components, which may be integrated as part of a printed circuit board, for example. Alternatively or additionally, the disclosed components or modules may be implemented as application specific integrated circuit (ASIC) and/or field programmable gate array (FPGA) devices. Additionally or alternatively, some implementations may include a digital signal processor (DSP), which is a dedicated microprocessor with an architecture optimized for the operational needs of digital signal processing associated with the disclosed functionality of the present application. Similarly, the various components or subcomponents within each module may be implemented in software, hardware or firmware. Connections between the modules and/or components within the modules may be provided by using any of the connection methods and media known in the art, including but not limited to communications over the Internet, wired networks, or wireless networks using appropriate protocols.

Some examples of the disclosure are as follows.

### Example 1. A Communication Method, Comprising

receiving, by the second node, an encrypted storage address and an encrypted random sequence from the first node, wherein the encrypted storage address and the encrypted random sequence are encrypted by using the public key;
decrypting, by the second node, the encrypted storage address and the encrypted random sequence by using a private key corresponding to the public key;
reading, by the second node, encrypted data from a memory according to the decrypted storage address, wherein the encrypted data is encrypted by using the first key;
generating, by the second node, a second key by using the decrypted random sequence; and
decrypting, by the second node, the encrypted data by using the second key.

### Example 2. The Method According to Example 1, Wherein the First Key and the Second Key are Generated by Using a Same Key Generation Algorithm

While exemplary embodiments or examples of the present disclosure have been described with reference to the accompanying drawings, it should be understood that the exemplary discussions above are not intended to be exhaustive or to limit the present invention to the specific forms disclosed. Many modifications and variations are possible in light of the above teachings. Therefore, the disclosed subject matter should not be limited to any single embodiment or example described herein, but should be construed in breadth and scope in accordance with the appended claims.

What is claimed is:

1. A communication method, comprising:
generating a first key by using a random sequence;
encrypting data by using the first key to generate encrypted data;
writing the encrypted data into a memory;
encrypting the random sequence and a storage address of the encrypted data in the memory by using a public key; and
sending the encrypted storage address and the encrypted random sequence to a second node from a first node.

2. The method according to claim 1, further comprising:
decrypting, by the second node, the encrypted storage address and the encrypted random sequence by using a private key corresponding to the public key; and
reading, by the second node, the encrypted data from the memory according to the decrypted storage address.

3. The method according to claim 2, further comprising:
generating, by the second node, a second key by using the decrypted random sequence; and
decrypting, by the second node, the encrypted data by using the second key.

4. The method according to claim 1, wherein writing the encrypted data to the memory comprises:
writing the encrypted data into a shared memory space of the memory.

5. The method according to claim 4, further comprising:
applying for a storage space in the shared memory space according to a size of the encrypted data; and
writing the encrypted data into the applied storage space.

6. The method according to claim 1, further comprising:
obtaining a first check code by using a check algorithm on the data;
encrypting the first check code by using the first key to generate an encrypted first check code; and
writing the encrypted first check code into the memory.

7. The method according to claim 6, further comprising:
decrypting, by the second node, the encrypted storage address and the encrypted random sequence by using a private key corresponding to the public key;
reading, by the second node, the encrypted data and the encrypted first check code from the memory according to the decrypted storage address;
generating, by the second node, a second key by using the decrypted random sequence;
decrypting, by the second node, the encrypted data and the encrypted first check code by using the second key;
obtaining a second check code by using a check algorithm on the decrypted data; and
determining whether the decrypted first check code matches the second check code.

8. The method according to claim 1, further comprising:
generating the public key and the corresponding private key in response to the second node being started; and
sending, by the second node, the public key to a third node.

9. The method according to claim 8, further comprising:
sending, by the third node, the public key to the first node in response to determining that the second node has a read permission.

10. The method according to claim 8, further comprising:
storing, by the third node, the public key in response to determining that the second node has a read permission; and
sending, by the third node, the public key to the first node in response to determining that the first node has been started and has a write permission.

11. The method according to claim 1, further comprising:
notifying, by the first node in response to being started, the third node that the first node has been started; and
notifying, by the third node, the second node that the first node has been started in response to being notified by the first node.

12. The method according to claim 8, wherein a configuration file is loaded when the third node is started, the configuration file comprising permission information of a plurality of nodes, the plurality of nodes comprising the first node and the second node, and the permission information comprising information on a read permission and a write permission.

13. The method according to claim 1, further comprising:
sending, by the second node, a link establishment request to the first node;
establishing, by the first node, a link with the second node in response to the link establishment request; and
associating, by the first node, the public key with the link.

14. A communication apparatus, comprising:
a processor; and
a memory storing program instructions, which when being executed by the processor, causing the apparatus to:
generate a first key by using a random sequence;
encrypt data by using the first key to generate encrypted data;
write the encrypted data into the memory;
encrypt the random sequence and a storage address of the encrypted data in the memory by using a public key; and
send the encrypted storage address and the encrypted random sequence to a second node from a first node.

15. The apparatus according to claim 14, wherein the program instructions, when being executed by the processor, further cause the apparatus to:
decrypt, at the second node, the encrypted storage address and the encrypted random sequence by using a private key corresponding to the public key; and
read, at the second node, the encrypted data from the memory according to the decrypted storage address.

16. The apparatus according to claim 14, wherein the program instructions, when being executed by the processor, further cause the apparatus to:
obtain a first check code by using a check algorithm on the data;
encrypt the first check code by using the first key to generate an encrypted first check code; and
write the encrypted first check code into the memory.

17. The apparatus according to claim 14, wherein the program instructions, when being executed by the processor, further cause the apparatus to:
generate the public key and the corresponding private key in response to the second node being started; and
send the public key from the second node to a third node.

18. A non-transitory computer-readable storage medium storing a program therein, wherein the program comprises program instructions, which when being performed by one or more processors of a computing apparatus, causing the apparatus to:
generate a first key by using a random sequence;
encrypt data by using the first key to generate encrypted data;
write the encrypted data into the memory;
encrypt the random sequence and a storage address of the encrypted data in the memory by using a public key; and
send the encrypted storage address and the encrypted random sequence to a second node from a first node.

19. The computer-readable storage medium according to claim 18, wherein the program instructions, when being performed by the one or more processors of the computing apparatus, further cause the apparatus to:
decrypt, at the second node, the encrypted storage address and the encrypted random sequence by using a private key corresponding to the public key; and
read, at the second node, the encrypted data from the memory according to the decrypted storage address.

20. The computer-readable storage medium according to claim 18, wherein the program instructions, when being performed by the one or more processors of the computing apparatus, further cause the apparatus to:
obtain a first check code by using a check algorithm on the data;
encrypt the first check code by using the first key to generate an encrypted first check code; and
write the encrypted first check code into the memory.
